(19) United States
(12) Patent Application Publication
(10) Pub. No.: US 2011/0000996 A1
(43) Pub. Date: Jan. 6, 2011

(54) Adaptive Load Limiting Seat Belt Retractor

(76) Inventors: Fredrik Wigström, Goteborg (SE); Henrik Götsten, Vargarda (SE); Henrik Friedlander, Vargarda (SE)

Correspondence Address: Brinks Hofer Gilson & Lione/Ann Arbor, 524 South Main Street, Suite 200, Ann Arbor, MI, 48104, US

(21) Appl. No.: 12/681,661

(22) PCT Filed: Oct. 5, 2007
(86) PCT No.: PCT/SE07/00884

§ 371 Date: Sep. 14, 2010

(51) Int. Cl. B60R 22/36; B60R 22/34

(52) U.S. Cl. 242/376

(57) ABSTRACT

A safety seat belt arrangement comprises a retractor or spool assembly including a spool (20), carrying the seat belt, rotatable in a frame (18) unless blocked by a blocking mechanism (25), the spool assembly including a head member (22) cooperating with the blocking mechanism. A load limiting torsion bar assembly within the spool and acting between the head member and the spool includes a high level torsion bar portion (24), a low level torsion bar portion (26) and an intermediate torsion element in the form of a torsion pipe (36) fixed at its ends with respect to the ends of the torsion bar portion (26). A torque tube (32) initially provides a direct drive connection between the outer end of the spool (20) and the outer end (24A) of the high level torsion bar portion, so that, in a frontal impact situation, in which the blocking mechanism blocks rotation of the head member, the torque applied to the spool by the belt tension is transferred to the head member principally via the high level torsion bar (24), limiting the belt tension to a relatively high level, until the torque tube is disconnected from the outer end of the spool in a changeover operation effected by a changeover mechanism (28, 40, 42) after which the belt tension is limited by twisting of the bar portion (26) and the torsion pipe (36) together, until the torsion pipe breaks, leaving rotation of the spool restrained only by twisting of the low level torsion bar part (26).

### CROSS REFERENCE TO RELATED APPLICATION

This application claims priority to PCT patent application PCT/SE2007/000884 filed Oct. 5, 2007.

### FIELD OF THE INVENTION

This invention relates to a load limiting mechanism for a seat belt retractor in a motor vehicle.

### BACKGROUND OF THE INVENTION

A seat belt retractor generally comprises a spindle or spool to which the seat belt is attached at one end and around which the seat belt is wound, the spindle having an associated retraction spring by means of which the spindle is rotated to take up slack in the seat belt and to retract the seat belt into a stored position when the seat belt is not in use. The seat belt can be drawn out from the reel at a relatively low rate to allow an occupant to fasten the seat belt about his person, but an associated blocking mechanism locks the spindle against such paying-out rotation in a crash situation. However, in such a crash situation, particularly in a high speed impact, the seat belt may impose very severe loads on the user in the course of the impact. Accordingly, in present day seat belt retractors, it is common to have some kind of load limiting device incorporated to limit the load applied by the seat belt to an occupant using the seat belt in the event of a vehicle impact. Such a load limiting device may be a torsion bar coupled to the spindle of the retractor and arranged so as to twist when a predetermined torque is applied to the spindle by the seat belt tension, so that the spindle rotates paying out a limited length of the seat belt to reduce the acceleration/deceleration of the occupant and hence reduce the inertia forces imposed on the occupant in the crash situation.

It is also known to provide a multi-stage load limiter mechanism for seat belt retractors in order to provide different load limiting characteristics at different stages in the course of the vehicle impact or to provide different load limiting characteristics in impacts of different kinds or of different severity. Such a multi-stage load limiting mechanism may utilise a torsion bar having several sections of different diameters or several connected torsion bars of different characteristics.

The present invention is particularly concerned with a multi-stage load limiting mechanism for a seat belt retractor which will, in an appropriate crash situation, (and given the presence of other occupant protecting devices such as air-bags) provide initially a high occupant restraining force via the seat belt and subsequently a lower seat belt restraining force.

The applicants have found that in a two-stage load limiting mechanism of the above kind, a problem arises in that, in the period of the change over of the load limiter from the higher restraining force to the lower restraining force the restraining force may actually dip below the level predetermined as the lower restraining force. This is believed to be due to a spring effect in the entire system, including, for example, the resilience of the seat belt webbing and of the vehicle structure itself and of the occupant's own body.

It is an object of the present invention to provide an improved multi-stage load limiting mechanism for a seat belt retractor.

According to the invention there is provided a safety seat belt arrangement comprising a spool assembly including a spool carrying, coiled thereon, an end portion of a seat belt, the spool assembly being mounted for rotation in a frame in the absence of blocking action applied by a blocking mechanism, the spool assembly including a head member which is arrested directly by said blocking mechanism when the blocking mechanism is operated and a load limiting torsion assembly acting between the head member and the spool, the torsion assembly comprising a first, high level, torsion element, a second, low level, torsion element and an intermediate torsion element, the arrangement being such that, in an impact situation, causing the blocking mechanism to operate to block rotation of the head member, in a first operating mode, the torque applied to the spool by the belt tension due to the deceleration of the person wearing the belt is transferred to the head member solely or principally via the first torsion element, whereby the tension in the belt is limited to a high load level limit, whilst in a second operating mode, operative after operation of the seat belt arrangement in said first mode for a period, the torque applied to the spool by the belt tension due to the deceleration of the person wearing the belt is transferred to the head member via the intermediate torsion element, or via the intermediate torsion element and the second torsion element in combination, whereby the tension in the belt is limited to an intermediate level load limit, whilst in a third operating mode, operative after operation of the seat belt arrangement in said second mode for a period, the torque applied to the spool by the belt tension due to the deceleration of the person wearing the belt is transferred to the head member exclusively by the low level torsion element whereby the tension in the belt is limited to the low level load limit.

Preferably the torsion elements are elements adapted to twist, allowing limited rotation of the spool relative to the head member and thus limited paying out of the seat belt, whilst undergoing plastic deformation, in order to limit the seat belt load.

In one embodiment, in the second mode, the torque applied to the spool is transmitted to the head member by the intermediate torsion element and the low level torsion element acting in parallel, until the intermediate torsion element breaks to establish the transition to said third mode in which the second torsion element alone provides torque transfer between the spool and the head member.

In this embodiment, the first and second torsion elements comprise respective parts, connected end to end, of a torsion bar accommodated within the spool, a junction region being provided between the first and second torsion elements, the end of the bar remote from the second torsion element being fixed with respect to the head member and the intermediate torsion element comprising a torsion tube within which the part of the torsion bar providing the second torsion element extends, the torsion tube being fixed at one end with respect to a junction region and at its other end with respect to the end of the second torsion element remote from the first torsion elements, the arrangement including means operative, in the first mode, to fix the spool directly with respect to the junction region, the last-mentioned means being inoperative in the second and third modes, in which the spool is fixed with respect to the torsion assembly only at the end of the torsion bar remote from said head member.

The means operative, in the first mode, to fix the spool directly with respect to the junction region preferably comprises a torque tube within which the torsion tube and the second torsion element extend and detent means acting at the end of the torque tube remote from the junction region to fix the last-noted end with respect to the spool during the first mode and to release the end of the torque tube from the spool in the second and third modes.

### BRIEF DESCRIPTION OF THE DRAWINGS

Embodiments of the invention are described below with reference to the accompanying drawings, in which:

FIG. 1 is a graph illustrating schematically the variation of belt force applied by a seat belt to a seat occupant (dummy occupant), with occupant displacement and hence with time, in a crash situation in which the occupant wears a seat belt with a seat belt retractor having a two-stage load limiting mechanism in accordance with the prior art,

FIG. 2 is diagrammatic view of a torsion bar utilised in the load limiting mechanism to which FIG. 1 relates,

FIG. 3 is a graph similar to FIG. 1 but illustrating the behaviour of a load limiting mechanism in accordance with the present invention,

FIG. 4 is a schematic view similar to FIG. 2 illustrating the modification of the mechanism of FIG. 2, in accordance with the invention and to which FIG. 3 applies,

FIGS. 5A, 5B and 5C respectively show, to the left-hand side, the graph of FIG. 3 to a smaller scale, and, to the right-hand side, schematically, the torsion bar arrangement of FIG. 4 at the corresponding stages indicated by the bold spot in the respective graph,

FIG. 6 is a view in section through a seat belt retractor spool incorporating the features of FIG. 4 and FIGS. 5A to 5C, and

FIG. 7 is a fragmentary perspective view of a variant of the retractor spool of FIG. 6.

### DETAILED DESCRIPTION OF THE INVENTION

A vehicle safety belt arrangement incorporating a load limiter as described below is intended to operate as follows in a crash situation in which the vehicle concerned encounters a frontal impact with another vehicle or with some other object. Where the impact occurs at high speed, such that an absolutely fixed seat belt would place excessively high loads on an occupant wearing the seat belt, the load limiter initially allows limited rotation of the seat belt retractor spool in response to a seat belt tension in excess of a predetermined high value, for a limited period. However, after such period, after the occupant has experienced some deceleration and when the associated vehicle airbag has begun to play its part in reducing the momentum of the occupant, the limiting tension in the seat belt should be reduced to a lower level.

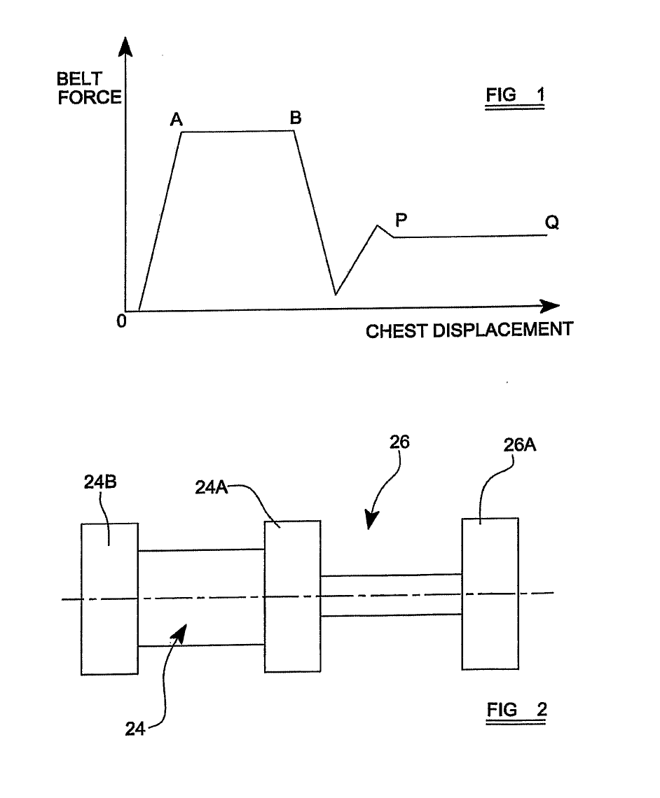

Referring to FIG. 1, in a two-stage load limiter mechanism for a seat belt retractor, from the beginning of the vehicle impact, indicated at origin O, there is a progressive increase in the load applied by the belt to the seat occupant up to point A in the graph at which the high level load limiter begins to operate to maintain a approximately constant restraining force on the occupant as the latter moves slightly forward during the impact, being decelerated all the while, up to the point B at which the mechanism changes over to provide the lower level restraining force, during the operational phase between points P and Q in FIG. 1. The seat belt arrangement, in manner known per se, includes a seat belt retractor having a spindle or spool to which the seat belt is attached at one end and around which the seat belt is wound, the spindle being rotatable in a fixed frame or mounting unless an associated blocking mechanism is operated, for example, in a crash situation. The retractor spool may be coupled to the blocking mechanism through a torque limiting arrangement incorporating a torsion bar of the form illustrated in FIG. 2, extending within a central passage in the spool and fixed at one end, via a portion 24B, to a head member (not shown in FIG. 2) which is directly blocked by the blocking mechanism. The torsion bar is fixed at its opposite end 26A to the retractor spool itself. The torsion bar comprises a relatively stiff, thicker, high level, torsion bar part 24 extending between root portion 24B and a land portion 24A, and a thinner, relatively pliable, low level, torsion bar part 26 extending between land portion 24A and end 26A. During the period from point O to point B in the graph of FIG. 1, the torque applied, by the belt tension, to the seat belt retractor spindle is applied to the land portion 24A, at the end of high level torsion bar part 24, the root portion 24B of which is effectively fixed by the seat belt blocking mechanism. The section A to section B of the graph of FIG. 1 corresponds to twisting of the torsion bar part 24 in response to this torque, with corresponding paying-out of the seat belt. The effect of a change-over mechanism, not shown in FIG. 2, is that the torque applied to the seat belt retractor spindle by the tension in the seat belt is subsequently applied to the head 26A of the low level torque bar section 26 rather than to land portion 24A. Due to the difference in diameter between the low level torsion bar part 26 and the high level torsion bar part 24, the magnitude of the seat belt restraining force is then determined, at least over the section P to Q in FIG. 1, by the resistance to twisting of the low level bar part 26, the corresponding torque being, of course, insufficient to twist the bar part 24 further. However, during the period of the changeover by means of the changeover mechanism referred to, of the load limiter mechanism from the higher level restraining force to the lower level restraining force, there is, between points B and P in the graph of FIG. 1, a dip of the belt restraining force below the level predetermined as the lower restraining force, i.e. the level of section P to Q, this dip being due, the applicants believe, to a spring effect in the entire system.

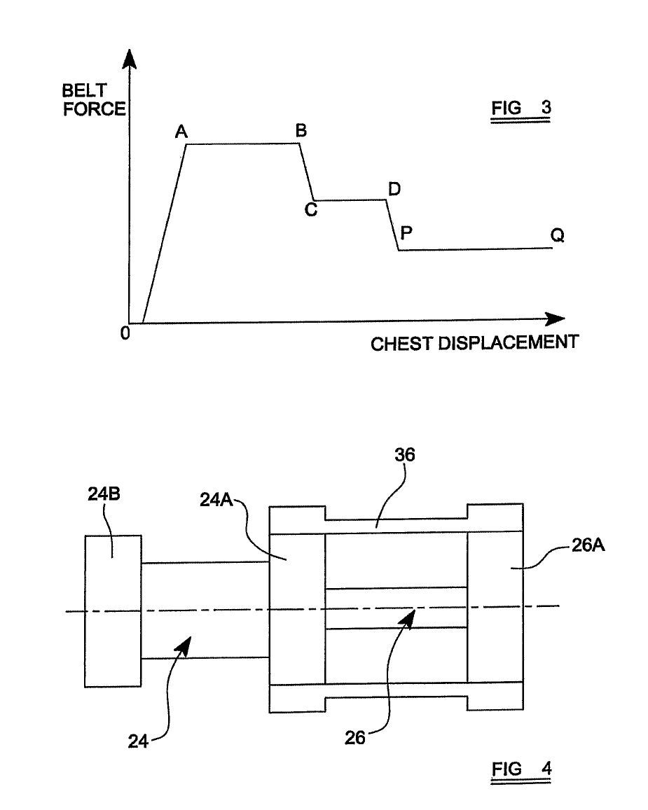

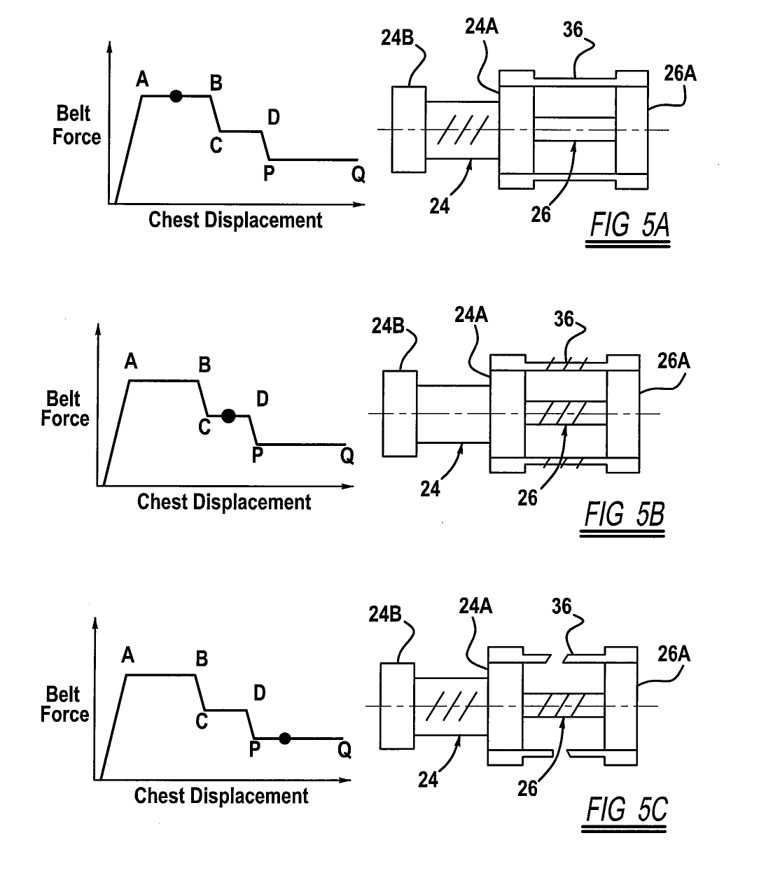

Referring to FIGS. 3 and 4, the mechanism illustrated schematically in FIG. 2 is modified by the addition of a torsion pipe 36 which is fixed at one end to the end 26A of the torsion bars 24 and 26 and at the other end to the land portion 24A. Accordingly, when the torque applied by the seat belt spindle is switched from the land 24A to the head 26A, the restraining force applied is determined by the combined resistance to twisting of the torsion pipe 36 and the low level torsion bar part 26, (this combined resistance still being lower than the resistance to twisting of the high level torsion bar part 24), until, at a predetermined point, the torsion pipe 36 breaks. Referring to the graph of FIG. 3, which corresponds to that of FIG. 1 over the sections O to A, A to B and P to Q, the region C to D of the graph corresponds to the phase in which the torsion pipe 36 is twisting and in which the seat belt restraining force is at a level intermediate the high level A-B and the predetermined low level P-Q. In practice, there may still be a dip in the region of point C in the graph, which will, however, have a higher minimum than the dip in FIG. 1 and will effectively be masked by the middle level restraint C-D. Thus, referring to FIGS. 5A to 5C, in which the diagonal lines indicate the part of the mechanism which is twisting to define the limiting restraining force, in FIG. 5A, the restraining force (at the level of the bolded point on the graph) is provided by the twisting of the high level torsion bar part 24 (shown with diagonal lines). In FIG. 5B, the restraining force (at the level of the bolded point on the graph) is defined by the combined twisting of the torsion pipe 36 and the low level torsion bar part 26 (shown with diagonal lines). Whilst in FIG. 5C where the torsion pipe 36 has broken, the restraining force (at the level of the bolded point on the graph) is defined solely by the twisting of the low level torsion bar part 26 (shown with diagonal lines).

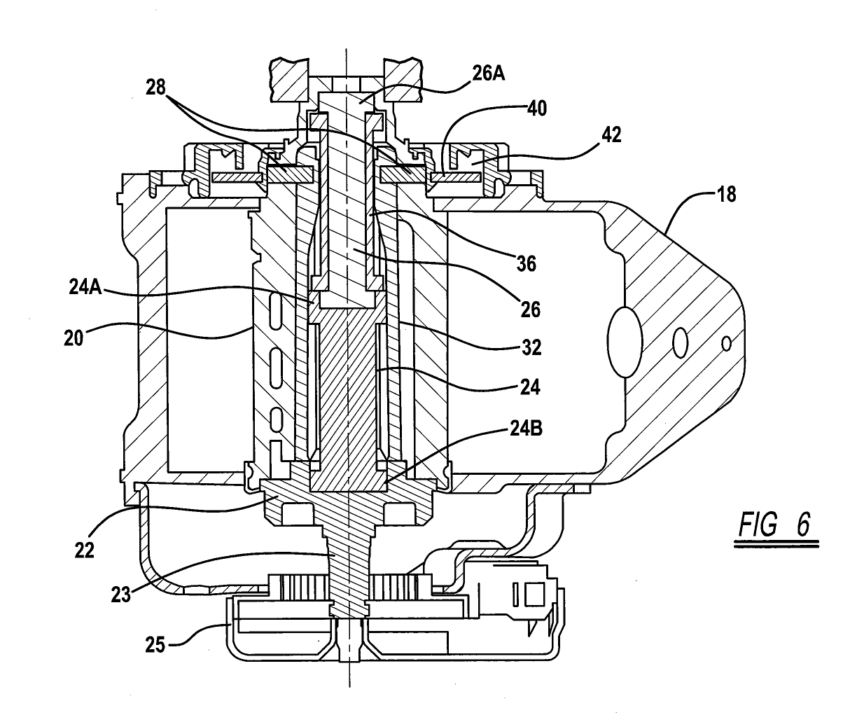

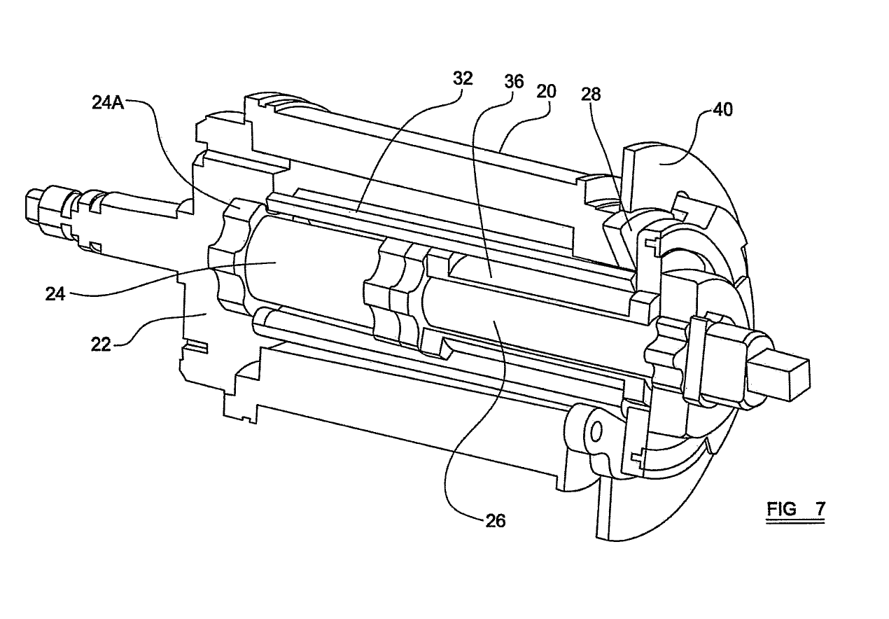

Referring to FIG. 6, which shows, in axial section through the seat belt retractor reel, a practical implementation of the arrangement described above with reference to FIGS. 3 to 5, and to FIG. 7, which shows a variant, a seat belt spool or spool 20 to which one end of the seat belt (not shown) is attached, is mounted in a frame 18 (shown only partially) for rotation in the frame against a seat belt retracting torsion spring (not shown) in normal use. In normal circumstances, one end of the spool 20 (the lower end in FIG. 6) receives a tread head 22 which has a shaft 23 extending into a conventional reel blocking mechanism indicated at 25. The spool 20 is hollow and receives co-axially therein a torque tube 32, which in turn receives, co-axially therein, a torsion bar of the form shown in FIGS. 2 and 4 comprising a large diameter high level torsion bar part 24, a low level torsion bar part 26 and an intervening land 24A. The torsion pipe 36 again extends between the land 24A and the end 26A of the low level torsion bar part 26 remote from land 24A. In normal use, i.e. in non-emergency situations, the torque tube 32 is fixed with respect to the spool 20 by means of pawls 28 at the upper end of the tube 32 and spool (as viewed in FIG. 6) which extend through respective radial slots in the spool 20 and engage in recesses in the upper end of the torque tube 32. However, as noted below, when the pawls 28 are removed, the torque tube 32 is free to rotate within the spool, subject to the restraining force provided by the low level torsion bar part 26 and the torsion pipe 36. The torque tube 32 has internal longitudinal splines which cooperate with corresponding grooves in the land 24A at the upper end of torsion bar part 24 (as viewed in FIG. 6). The lower end 24B of torsion bar part 24 is fixed against rotation relative to the tread head 22, for example by cooperating splines and grooves in the lower end 24B of the torsion bar 24 and the tread head 22. The lower end of the torque tube 32 is not fixed to the tread head 22. Whilst the pawls 28 are in place, the torque applied by the spool 20 is transferred by the pawls 28 to the torque tube 32 which acts after the fashion of a box spanner with respect to the land 24A of the torsion bars 24 and 26. Accordingly, when in an impact situation, the tread head 22 is locked by the seat belt blocking mechanism, the torque applied to the spool 20 by the belt causes the spool, the torque tube 32, the land 24A, the upper end of torsion bar part 24, the low level torsion bar part 26 and the torsion pipe 36 all to rotate as one as the torsion bar part 24 twists, (undergoing plastic deformation).

As best shown in FIG. 6, the pawls 28 are normally held in engagement with the corresponding recesses in the upper end of the torque tube 32 by a circumferential piston ring 40. However, at a predetermined stage, in an impact crash situation, a gas generator is ignited, moving an annular piston 42 downwardly, (in FIG. 6) in an annular cylinder, in turn moving ring 40 out of engagement with the radially outer ends of the pawls 28. The profile (not shown) of the portions of the pawls 28 in engagement with the torque tube and the profile of the corresponding recesses in the torque tube are such that twisting of the spool 20 relative to the upper end of the torque tube 32 then displaces the pawls radially outwardly so that the spool 20 is no longer fixed with respect to the upper end of the torque tube.

Once the pawls 28 are disengaged, the spool 20, with the upper ends of the torsion pipe 36 and of the low level torsion bar 24, which upper ends are both fixed with respect to the upper end of the spool body (as viewed in FIG. 6), for example having splines engaging in respective grooves in the upper end of the spool body, rotate as both the torsion tube 36 and torsion bar part 26 twist, undergoing plastic deformation, until the torsion tube 36 breaks, after which further rotation of the spool occurs restrained only by the torsion bar 26 undergoing further twisting.

The torsion pipe 36 may be fixed directly to the torsion bars 24 and 26 at its upper and/or lower ends or may be fixed indirectly, so that, for example, the pipe 36 may have a grooved collar at its lower end (in FIG. 6) cooperating with the internal splines in the torque tube 32, thereby effectively fixing the lower end of the torsion pipe with respect to land 24A, which is likewise fixed by splines in the torque tube. Such an arrangement is shown on FIG. 7. Likewise the torsion bar 24, 26 may be formed in two parts, namely part 24 providing land 24A with grooves engaging the splines in torque tube 32 and part 26 providing at its lower end in FIG. 6 a grooved collar also engaging in the internal splines in the torque tube 32, as in the variant illustrated in FIG. 7. These are, of course, matters of design choice.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

While the above description constitutes the preferred embodiment of the present invention, it will be appreciated that the invention is susceptible to modification, variation, and change without departing from the proper scope and fair meaning of the accompanying claims.

1. A safety seat belt arrangement comprising a spool assembly including a spool adapted for carrying, wrapped thereon, an end portion of a seat belt, the spool assembly being mounted for rotation in a frame, a blocking mechanism for applying a blocking action on the spool, the spool assembly including a head member which is arrested by the blocking mechanism when the blocking mechanism is operated, and a load limiting torsion assembly acting between the head member and the spool, the torsion assembly including a high level, torsion element, a low level, torsion element and an intermediate torsion element, wherein in an impact situation, causing the blocking mechanism to operate to block rotation of the head member, in a first operating mode, the torque applied to the spool by the belt tension due to the deceleration of the person wearing the belt is transferred to the head member to the first torsion element, whereby the tension in the belt is limited to a high load level limit, while in a second operating mode, operative after operation of the seat belt arrangement in the first mode, the torque applied to the spool by the belt tension due to the deceleration of the person wearing the belt is transferred to the head member to the intermediate torsion element, whereby the tension in the belt is limited to an intermediate level load limit, whilst in a third operating mode, operative after operation of the seat belt arrangement in the second mode and upon the breaking of the intermediate torsion element, the torque applied to the spool by the belt tension due to the deceleration of the person wearing the belt is transferred to the head member by the low level torsion element whereby the tension in the belt is limited to a low level load limit.

2. A seat belt arrangement according to claim 1 wherein the high, low, and intermediate torsion elements are adapted to twist, allowing limited rotation of the spool relative to the head member and thus limited paying out of the seat belt, while undergoing plastic deformation, in order to limit the seat belt load.

3. A seat belt arrangement according to claim 1 wherein, in the second mode, the torque applied to the spool is transmitted to the head member by the intermediate torsion element and the low level torsion element acting in parallel, until the intermediate torsion element breaks to establish a transition to the third mode in which the low level torsion element provides torque transfer between the spool and the head member.

4. A seat belt arrangement according to claim 3 wherein the high level and the low level torsion elements comprise respective parts, connected end to end, of a torsion bar accommodated within the spool, a junction region being provided between the high level and the low level torsion elements, an end of the bar remote from the low level torsion element being fixed with respect to the head member and the intermediate torsion element comprising a torsion tube within which the low level torsion bar extends, the torsion tube being fixed at one end with respect to the junction region and at its other end with respect to the end of the low level torsion element remote from the high level torsion element, the arrangement including means for fixing the spool in the first mode with respect to the junction region, the means of fixing being inoperative in the second and third modes, in which the spool is fixed with respect to the torsion assembly only at the end of the torsion bar remote from the head member.

5. A seat belt arrangement according to claim 4 in which the means for fixing the spool comprises a torque tube within which the torsion tube and low level torsion element extends and detent means for acting at the end of the torque tube remote from the junction region to fix the end with respect to the spool during the first mode and to release the end of the torque tube from the spool in the second and third modes.

6. A seat belt arrangement according to claim 5 wherein the detent means is operable by a release mechanism at the end of the first mode.

7. A seat belt arrangement according to claim 6 wherein the release means is operated by a pyrotechnic device.

8. A seat belt arrangement according to claim 1 wherein upon the breaking of the intermediate torsion member, the intermediate torsion member is not transfer capable of generating a restraining torque.
